(19) United States
(12) Patent Application Publication
(10) Pub. No.: US 2013/0042010 A1
(43) Pub. Date: Feb. 14, 2013

(54) ACCESS ESTABLISHMENT TO LOCALLY CONNECTABLE DEVICE

(71) Applicants: Jukka Reunamaki, Tampere (FI); Arto Palin, Viiala (FI)

(72) Inventors: Jukka Reunamaki, Tampere (FI); Arto Palin, Viiala (FI)

(73) Assignee: Nokia Corporation, Espoo (FI)

(21) Appl. No.: 13/521,506

(22) PCT Filed: Jan. 28, 2010
(86) PCT No.: PCT/FI10/50046

§ 371 Date: Jul. 11, 2012

(51) Int. Cl. G06F 15/16

(52) U.S. Cl. 709/227

(57) ABSTRACT

In a non-limiting and exemplary embodiment, a method is provided for arranging access to locally connectable devices. A target direction is estimated on the basis of a user input. A communication device residing substantially at the target direction is defined. Before or after the identification of the communication device, access information associated with the communications device is received without establishing a connection to the communication device and without any information of earlier connection to the communication device. The device at target direction communication device and/or a service is connected on the basis of the access information associated with the identified communication device.

### FIELD

The invention relates to arranging access to locally connectable devices.

### BACKGROUND

Various communication technologies exist for local connectability between electronic devices. Some examples of such technologies include widely applied IEEE 802.11 based wireless local area network technologies and Bluetooth. Besides mobile communications devices, various domestic and consumer electronic appliances are increasingly equipped with wireless communications units for local connectivity. Similarly, locally connectable access devices exist in various spaces, such as offices, airports, coffee shops, etc. For instance, a user may wish to connect to a home entertainment system as well as an Internet gateway device when entering a rented holiday cottage.

Selection of a locally available device and establishment of a connection to a locally available device and a service should be as easy as possible for the user. Typically this involves a priori negotiation between a user device and a device being connected to, and also requires the user to perform various user inputs in selection and connection establishment phases. In some access technologies available networks are automatically scanned and the user is prompted to confirm if an available network is to be connected.

### BRIEF DESCRIPTION

A method, apparatuses, and a computer program product for facilitating access establishment to locally connectable devices are provided, characterized by what is stated in the independent claims. Some embodiments of the invention are described in the dependent claims.

According to an embodiment of the invention, an apparatus is provided, the apparatus comprising: at least one processor; and at least one memory including computer program code, the at least one memory and the computer program code configured to, with the at least one processor, cause the apparatus to perform at least the following: determine a target direction on the basis of a user input; identify a communication device residing substantially at the target direction; receive, before or after the identification of the communication device, access information associated with the communication device without establishing a connection to the communication device and without any information of an earlier connection to the communication device; and connect the communication device and/or a service on the basis of the access information associated with the identified communication device.

According to another embodiment, an apparatus is provided, the apparatus comprising means for determining a target direction on the basis of a user input; means for identifying a communication device residing substantially at the target direction; means for receiving, before or after the identification of the communication device, access information associated with the communication device without establishing a connection to the communication device and without any information of an earlier connection to the communication device; and means for connecting the communication device and/or a service on the basis of the access information associated with the identified communication device.

According to another embodiment, a method is provided for determining a target direction on the basis of a user input; identifying a communication device residing substantially at the target direction; receiving, before or after the identification of the communication device, access information associated with the communication device without establishing a connection to the communication device and without any information of an earlier connection to the communication device; and connecting the communication device and/or a service on the basis of the access information associated with the identified communication device.

The invention and various embodiments thereof provide several advantages, which will become apparent from the detailed description below.

### LIST OF DRAWINGS

Embodiments of the present invention are described below, by way of example only, with reference to the accompanying drawings, in which

FIG. 1 illustrates an example of a communications system;

FIG. 2 illustrates an apparatus according to an embodiment;

FIG. 3 illustrates a method according to an embodiment;

FIG. 4 illustrates gaze tracking according to an embodiment;

FIG. 5 illustrates a method applying direction of arrival estimation according to an embodiment;

FIG. 6 illustrates an apparatus for direction of arrival estimation according to an embodiment;

FIG. 7 illustrates a method applying object identification according to an embodiment;

FIGS. 8a and 8b illustrate Network on Terminal Architecture (NoTA) features; and

FIGS. 9a and 9b illustrate access information associated with locally connectable devices according to some embodiments.

### DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

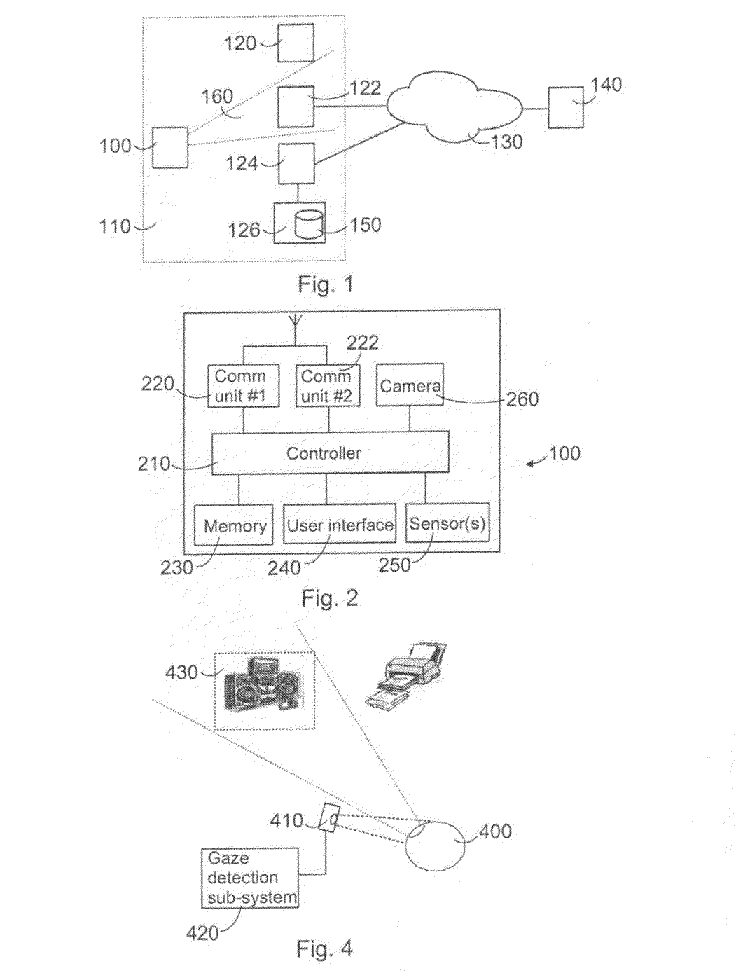

As illustrated in simplified FIG. 1, a local environment 110 of a wireless communication apparatus 100 may comprise a number of electronic devices 120, 122, 124, 126 which the apparatus 100 may connect to. For instance, the area 110 may represent a room, a house or an office. Some devices 122, 124 may be connected to one or more further networks 130, such as a mobile communications network, an operator's Internet access network, intranet, or various resources connected to the Internet.

According to an embodiment the system comprises a database for maintaining dynamic access information on locally connectable devices 120 to 126. The access information may be provided, together with further access information on other locally connectable devices, from a local access information server maintaining a dynamic database on locally connectable devices and associated access information. This access information may be provided for communications apparatuses 100 visiting the local environment. Such database may be locally available as a database 150 within or connectable to a local device 126. The database could also be located outside the local environment, for instance on a server 140, which may be connected to the Internet. The database may be updated whenever a new communications device 100, 120 to 126 is connected to the environment. As indicated in FIG. 1, according to some embodiments a user of the apparatus 100 may indicate a target device 122 by pointing to the device. The apparatus 100 is arranged to define a target direction 160 on the basis of the user input and identify a target device, i.e. the device being pointed, residing at the target direction. Access information available at the network, e.g. in the database 150, is obtained and used to connect the pointed device 22.

FIG. 2 illustrates a simplified embodiment of an apparatus according to an embodiment. The units of the apparatus may be part of the communications apparatus 100. The apparatus comprises a controller 210, at least one communications unit 220, 222, a memory 230, a user interface 240 with components for user input and output, and at least one antenna for wireless communications.

In accordance with an embodiment, the apparatus 100 also comprises one or more sensors 250, such as an orientation sensor providing information on the direction of the apparatus 100 or a portion of the apparatus 100. Such sensor(s) may be applied to selecting a communications device to be accessed. For instance, the apparatus 100 may comprise a magnetometer, the output of which may be used in some embodiments by the controller 210 to determine the direction of the apparatus 100. The apparatus 100 may also comprise an image sensor or a camera 260, which may be capable of storing video data.

The apparatus 100 may be implemented as an electronic digital computer, which may comprise memory, a processing unit with one or more processors and a system clock. The processing unit may be adapted to implement the controller 210. The processing unit may be controlled by a sequence of program instructions transferred to the processing unit from the memory, such as the memory 230 illustrated in FIG. 2.

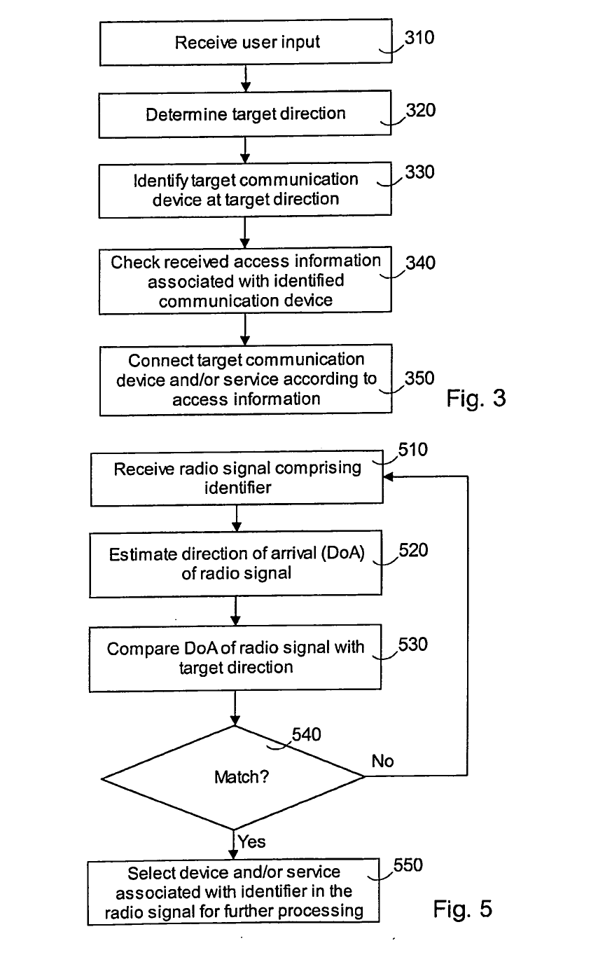

An embodiment provides a computer program embodied on a computer-readable storage medium. Such computer program comprises one or more sequences of one or more instructions which, when executed by one or more processors of the apparatus, cause the apparatus to perform at least some of the control features illustrated below in connection with FIGS. 3 to 7.

Such computer program code is stored in at least one memory of the apparatus, for instance the memory 230. The memory and the computer program code are configured, with at least one processor of the apparatus, to provide means for and cause the apparatus to perform at least some of control features and algorithms illustrated below in connection with FIGS. 3 to 7 below. The computer program may be in source code form, object code form or in some intermediate form.

At least some units of the apparatus, such as the controller 210, could be in a form of a chip unit or some other kind of hardware module for controlling an electronic device. Such hardware module comprises an interface to connect the hardware module to the device mechanically and/or functionally. The hardware module may form part of the communications apparatus 100. Some examples of such a hardware module include a sub-assembly or an accessory device. Such an apparatus providing the controller 210 could be a chipset or an integrated circuit suitable for use in a mobile station or a portable computer, for instance.

At least some of the features of the apparatus illustrated further below could be implemented by one or more integrated circuits, such as application-specific integrated circuits (ASIC). Other hardware embodiments are also feasible, such as a circuit built of separate logic components. A hybrid of these different implementations is also feasible.

Although the apparatus and the controller 210 are depicted as a single entity, different modules and memory may be implemented in one or more physical or logical entities. For instance, the controller 210 could comprise a specific functional module for carrying out one or more of the steps illustrated in connection with FIGS. 3 to 7. Further, there may be multiple sub-systems or modules, possibly implemented by a separate hardware unit, forming the controller 210. Further, the communications units 220, 222 are illustrated as single entities, and it will be appreciated that several units or modules may form a communications unit supporting one or more wireless communications protocols.

It should be appreciated that the apparatus 100 may comprise other structural and/or functional units not discussed in more detail here. For instance, the apparatus may comprise a positioning unit connected to the controller 210 and providing location information on the apparatus.

In general, the various embodiments of the apparatus 100 and also the further electronic devices 120 to 126 may include, but are not limited to, cellular telephones, personal digital assistants (PDA), portable computers, imaging devices, gaming devices, media players, such as music or video storage and playback appliances, Internet appliances permitting Internet access and browsing, as well as other handheld electronic units or terminals. The apparatus 100 may comprise any combination of these devices and may be embedded in a further electronic device. In some embodiments the apparatus 100 may comprise two or more physically connectable units.

Let us now study some embodiments illustrating how the apparatus 100 may be arranged to select and connect to one or more locally connectable communications devices 120 to 126.

FIG. 3 illustrates a method according to an embodiment for arranging access to a locally connectable communications device such as the device 120-126. In step 310 at least one user input indicating a direction of a target device is received. A target direction is determined 320 on the basis of the user input(s). Various pointing input techniques, such as gaze tracking, may be applied, as will be illustrated below in further detail. Step 320 may be carried out in response to detecting a user input indicating device selection.

At least one communication device 120-126, residing substantially at the target direction, is identified 330 as the target communication device. It will be appreciated that the definition of the target direction may involve defining a predetermined angle, and devices which are identified to be located within this angle range are identified as potential target devices residing at the target direction. Depending on the implementation, an angle of around 5 to 75 degrees may be applied as the range, for instance. The identification step 330 may also involve additional selection step of the target communication device among a plurality of potential communication devices at the target direction.

Before or after the identification 330 of the communication device, access information associated with the communications device is received without establishing a connection to the communication device. The access information may be obtained without any help of the selected communication device or information obtained on the basis of an earlier connection to the communication device. Access information of a plurality of nearby communications devices may be transferred by local broadcast transmissions, for instance. Access information regarding devices in the current surrounding area 110 of the apparatus 100 may be automatically requested or received from the local access information server 126, 140.

An identifier, such as a hardware identifier or a tag identifier of the communications device is obtained, for instance in connection with step 330. Access information associated with an identifier matching the identifier of the communication device identified and selected at step 330 is checked 340. Some other kind of identification can be applied, instead of a device specific identifier, to identify 330 the communication device and find associated access information. For instance, the shape of the device may be identified and access information associated with the shape may be searched for and selected in step 340. Step 340 may involve accessing the memory 230 of the apparatus 100 or requesting the access information from a server 126, 140.

The communication device and/or an associated service is then connected 350 on the basis of the access information associated with the identified communication device. The term “service” is to be understood broadly to cover various features provided by or via the communication device, including also functions of an application or operating system of the communication device.

Various modifications may be made to the procedure illustrated in FIG. 3. For instance, there may be an additional step of prompting the user to confirm that the identified communication device is to be connected. Further, the nearby communication devices and their directions may be identified before receiving a user input indicating the desired target direction and that step 330 may involve identifying a device substantially residing at the target direction. The user of the apparatus 100 may be informed of the selected device. For instance, a name or another identifier of or an image representing the device may be displayed.

Thus, the procedure of FIG. 3 further facilitates selection of and access establishment to a locally connectable communications device. The user is only required to indicate a direction of this communication device and the procedure may take care of further actions to identify the device and required access settings, and establish a connection to this device. There are various further embodiments for carrying out the steps of FIG. 3, some of which will be further illustrated below.

In some embodiments, the apparatus 100 is arranged to determine 320 the target direction on the basis of a gaze direction estimated by a gaze tracking module. Gaze tracking generally refers to tracking eye movement. An estimated direction of user's gaze, i.e. the point of gaze may serve as the user input for target direction definition for the controller 210. A further specific user input, such as a blinking of an eye or pressing of a button, may be applied for selecting the target direction.

There are a number of gaze tracking techniques which are suitable for the present device pointing detection purposes. In some embodiments the tracking module comprises one or more video cameras and the eye position is extracted from video images. Other examples of available methods include application of search coils or an electro-oculogram. However, it is to be noted that various current or future gaze direction estimation methods may be applied in the present embodiments.

As illustrated in FIG. 4, at least one video camera 410 may be applied and focused to a user's eye 400. The video camera is connected to a gaze tracking sub-system 420, which may be connected or implemented by the controller 210. The gaze tracking sub-system 420 provides information on the direction of the user's gaze, which may be used to select 430 the target device, such as a home entertainment system.

The gaze tracking module may be head-mounted, fixedly mounted or mounted in a handheld device, such as a mobile phone. There may be one or more assisting units, such as a magnetic or video-based head movement tracker. For instance, the gaze tracking module may be implemented on eye glasses, which may be wirelessly connected to a main body of the apparatus 100, or the eye glasses may comprise further units of the apparatus 100. The gaze tracking module may be a sub-system of or connected to the controller 210.

Thus, an object which the user looks at may be identified and connected to with minimal effort being required from the user. This embodiment enables various possibilities and appliances for local connectivity. The present features may be applied for increasing safety in various usage conditions, since user's attention is not required for entering input on a conventional tactile user interface. For instance, the present features may be applied for selecting and controlling devices and services in a vehicle by gaze detection, whereby it becomes possible to enhance driving safety.

It will be appreciated that gaze estimation on the basis of target direction definition is only one example of available techniques. For instance, user gesture detection, speech recognition, and/or tactile input may be applied for determining and confirming the target direction. In one embodiment the target direction is defined 320 on the basis of sensed orientation of the apparatus 100 or a portion of the apparatus 100. Thus, an output from an orientation sensor, such as a magnetometer serving as a digital compass, is used for determining the target direction.

In some embodiments, the apparatus 100 is arranged to identify 330 devices substantially at the target direction on the basis of direction of arrival of radio signals of the communication devices 120-126. Reference is made to a method illustrated in FIG. 5. The steps of FIG. 5 may be applied in the controller 210 and in connection with step 330 of FIG. 3.

A radio signal comprising at least one identifier of at least one locally connectable device 120-126 is received 510. Depending on the applied radio technology, the radio signals may be passively monitored and/or a stimulus signal or a request signal may be first transmitted to get the radio signals from the locally connectable devices. A direction of arrival (DoA) of the received radio signal is estimated 520.

The DoA of the received radio signal is compared 530, 540 to the target direction identified on the basis of the user input. If there is a match, the device is selected 550 as the target device. The device may be identified on the basis of an identifier, such as a Media Access Control (MAC) address, received in the radio signal. Thus, at least one identifier received from the same direction as the direction indicated by the user input may be selected for further processing. A service associated with the selected device may be selected in step 550. Access information may then be acquired for the selected device and/or service as illustrated in connection with step 340 of FIG. 3. For instance, the apparatus 100 may thus send the identifier to the server 126, 140 capable of mapping the identifier with associated access information.

If there is no match in step 540, the process may continue monitoring 510 the received radio signals. This may be continued for a predetermined time after which the user is informed that no devices are at the currently pointed direction.

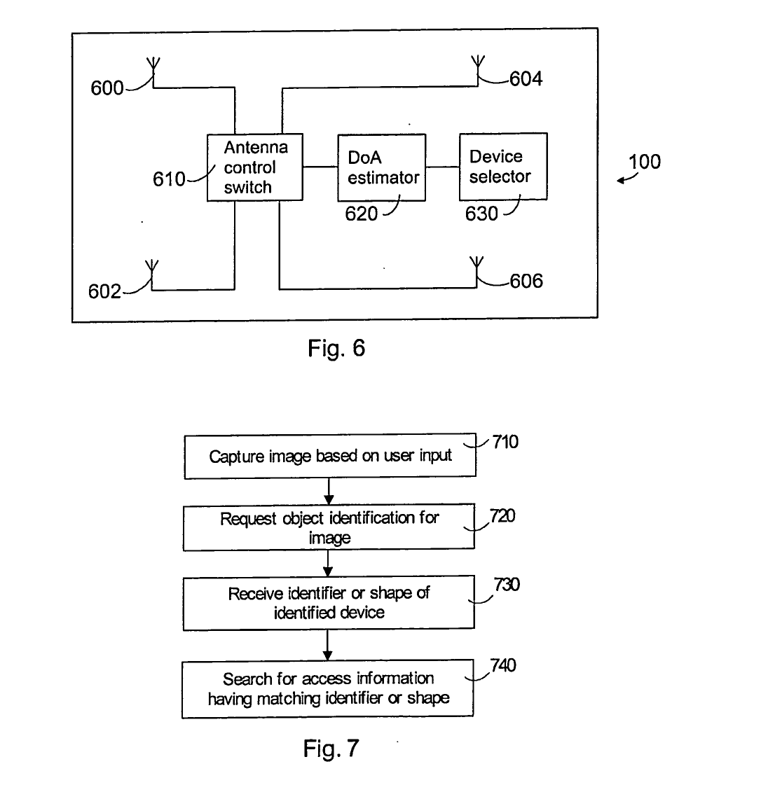

There are a number of DoA estimation methods available for arranging step 520, some of these methods being also referred to as ‘find and do’ technologies to search for nearby devices. FIG. 6 illustrates an embodiment for arranging the DoA estimation. An array of a plurality of antennas 600, 602, 604, 606 is arranged in the apparatus 100. It will be appreciated that the number of antennas does not have to be four but it can be any number larger than one.

The antennas are connected to an antenna control switch 610, which multiplexes the signals from the antennas and feeds the signals to a DoA estimator 620. The DoA estimator 620 may be arranged in a conventional receiver or as a dedicated DoA receiver in addition to a conventional receiver. The DoA estimator operates on signal phase and possibly amplitude information to determine a direction of the signal and thus the access device emitting the signal. The DoA estimator 620 provides DoA estimation data to a device selector 630, which may be provided by the controller 210. The device selector 630 may be arranged to perform steps 530 to 550 of FIG. 5.

In one embodiment a Bluetooth or Bluetooth Low End Extension (BTLEE) receiver is applied and the DoA is estimated on the basis of Bluetooth signal. Further information on some methods for DoA estimation is available in US2008/0068265, in particular on pages 5 to 9. It will be appreciated that application of DoA estimation with the present embodiments is not limited to any particular radio technologies. There may also be further modules and inputs, such as movement and/or orientation sensor(s) used by the controller 210 in connection with DoA estimation and/or device selection.

It is also noted that the DoA based device identification embodiment may be combined with the user pointing detection, as illustrated in connection with FIG. 4. For instance, the apparatus 100 may be arranged to use DoA based find and do technology to detect nearby communication devices 120 to 126 and determine the target direction 160 by gaze pointing before or after the device detection.

In some embodiments an object identification procedure is applied to identify 330 the target device or potential target devices. FIG. 7 illustrates a method according to an embodiment, which may be carried out by the controller 210, for instance. An image is captured 710 on the basis of a user input, such as input 310 or a further input in step 330. Object identification is requested 720 on the basis of the captured image data or further processed image data. For instance, a network server 126, 140 may be provided with an object identification service providing an identifier or a shape of the identified device.

If the identification process is successful, in step 730 a response containing an identifier or a shape of the identified device is received. Access information having an identifier or a shape substantially matching with the received identifier or shape is searched for 740. If access information with a matching identifier or shape is found, such access information is used for connecting the target communication device and/or service in step 350.

In an alternative embodiment the apparatus 100 comprises an object identification sub-system, which carries out the object identification instead of steps 720 and 730. In a further alternative embodiment the access information is searched for by an external entity, such as the server 126, 140, and the apparatus 100 is provided with the matching access information to be checked in step 340. This embodiment may be combined with various further embodiments. For instance, the steps of FIG. 7 may be applied after the gaze pointing and/or the DoA estimation based target device selection illustrated above.

As already indicated, the access information on locally connectable communication devices 120-126 may be received by the apparatus 100 before or after the identification 330 of the communication device, without establishing a connection to the communication device and without any information of an earlier connection to the communication device. Thus, there may be a further receiving step before or after step 330. This enables to save resources, since information on all locally connectable devices may be transmitted by a single connection without having to separately establish connections to each local device. The information may be transmitted by the server 126, 140 in response to a request from the apparatus 100 or automatically after local detection of the apparatus, for instance. The provision of the access information may be subject to authorization checking, i.e. the server checks if the visiting apparatus 100 is authorized to receive the access information. In one embodiment the server 126, 140 and the apparatus 100 support a Network on Terminal Architecture (NoTA) technique, which is used for delivering the access information and/or object identification information to the apparatus 100.

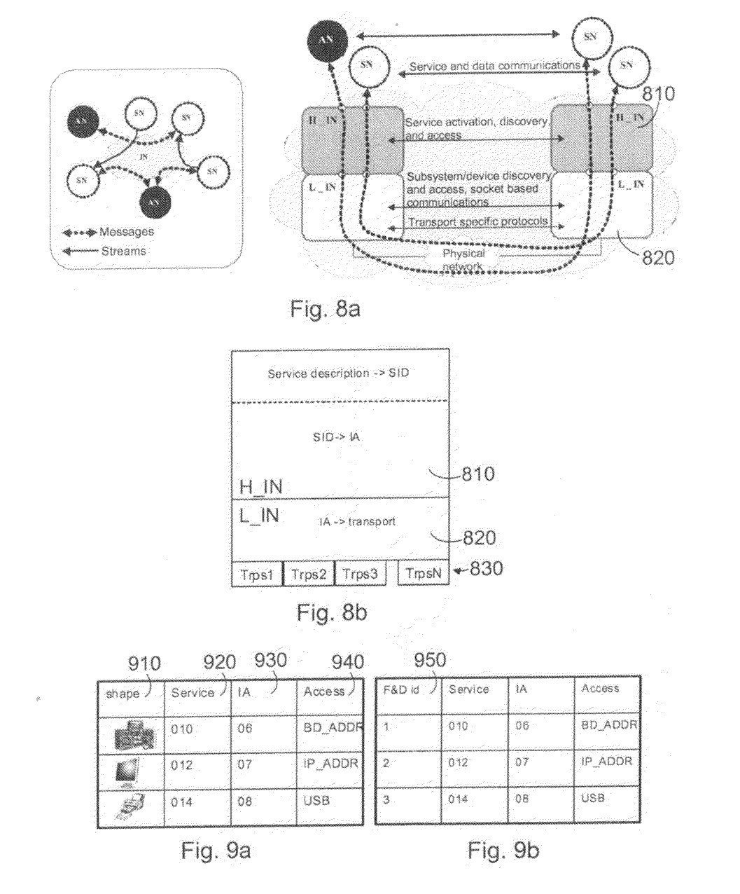

FIG. 8a illustrates the NoTA architecture and data flows between NoTA entities. The NoTA Interconnect consists of two layers, namely High Interconnect (H_IN) 810 and Low Interconnect (L_IN) 820. The L_IN layer 820 includes ISO/OSI layers 1 to 4 and provides transport socket type of interface for upper layers. The High Interconnect layer 810 acts as middleware between the L_IN layer 820 and upper application nodes (AN) and service nodes (SN). NoTA service activation, discovery and access signalling information is exchanged by the H_IN layer 810. As further illustrated in FIG. 8a, the application nodes AN may communicate signalling messages with service nodes SN, and service and data communication streams are transferred between the service nodes. In some embodiments the apparatus 100 is arranged to use the NoTA layer 810, 820 services for establishing a connection to the selected device in step 350.

FIG. 8b illustrates the principle of NoTA addressing scheme. A Resource Manager (RM) is an entity which allocates a service identifier (SID) when services register themselves with the RM. An application can then query the RM for these services and provide the information they need for connecting. An L_IN 820 level manager, typically in the same entity as the RM, may be arranged to allocate Interconnect Addresses (IA)to devices 120 to 126 in the local area 110. The H_IN 810 layer provides service identifier (SID) and IA mapping to identify devices offering the service. The L_IN 820 layer provides IA to transport mapping to identify physical access options for a device offering the service. An L_IN 820 level Connectivity Map Protocol (CMAP) is able to provide IA and transport mapping information, including transport-specific connection information, to other devices in a transport independent manner, i.e. information on any transport can be shared over all transports 830 (Trps1-N).

In some embodiments the access information comprises at least one of: one or more identifiers associated with the communication device, one or more access parameters associated with the communication device and service information on services available via the communication device.

FIG. 9a illustrates an embodiment of a table associating device shape information 910, service information 920 and further access information 930, such as NoTA IA information, with an address or identification 940 of a local connectivity method. For instance, Bluetooth addresses (BD_ADDR), Internet addresses (IP_ADDR), or USB could be identified in section 940. FIG. 9b illustrates an embodiment of a table associating device identifier information 950, such as a find and do identifier, service information, and further access information. The information illustrated in FIGS. 9a and 9b may be used as the access information on the locally connectable devices as illustrated above, and accessed by the NoTA, for instance. However, it will be appreciated that the access information on locally connectable devices is not limited to any particular forms or parameters.

It is to be noted that the above features represent only some examples of available ways to facilitate selection of and access to locally connectable devices. Various modifications can be made and some of the steps may be carried out in a different order.

It will be obvious to a person skilled in the art that as technology advances, the inventive concept may be implemented in various ways. The invention and its embodiments are not limited to the examples described above but may vary within the scope of the claims. The combinations of claimed elements as stated in the claims may be changed in a number of different ways and still be within the scope of the various embodiments of the invention.

1. A method comprising:
determining a target direction on the basis of a user input;
identifying a communication device residing substantially at the target direction;
receiving, before or after the identification of the communication device, access information associated with the communication device without establishing a connection to the communication device and without any information of an earlier connection to the communication device; and
connecting the communication device and/or a service on the basis of the access information associated with the identified communication device.

2. The method according to claim 1, wherein the step of determining the target direction comprises estimating gaze direction by a gaze tracking module.

3. The method according to claim 1, wherein the step of identifying the target communication device comprises receiving a radio signal comprising at least one identifier of at least one locally available communication device, estimating a direction of arrival of the received radio signal, determining which identifiers are received substantially from the same direction as the target direction identified on the basis of the user input, and selecting at least one identifier received substantially from the same direction as the direction identified on the basis of the user input.

4. The method according to claim 1, wherein the step of identifying the target communication device comprises
capturing an image on the basis of the user input; and
performing or requesting an object identification procedure on the basis of the captured image resulting in an identifier or a shape, wherein
the access information comprises an identifier or a shape substantially matching with the identifier or the shape obtained as the result of the object identification procedure.

5. The method according to claim 1, wherein the access information comprises at least one of: one or more identifiers associated with the communication device, one or more access parameters associated with the communication device, and service information on services available via the communication device.

6. The method according to claim 1, wherein the access information is received, together with further access information on other locally connectable devices, automatically from a local access information server maintaining a dynamic database on locally connectable devices and associated access information.

7. An apparatus, comprising:
at least one processor; and
at least one memory including computer program code,
the at least one memory and the computer program code configured to, with the at least one processor, cause the apparatus to perform at least the following:
determine a target direction on the basis of a user input;
identify a communication device residing substantially at the target direction;
receive, before or after the identification of the communication device, access information associated with the communication device without establishing a connection to the communication device and without any information of an earlier connection to the communication device; and
connect the communication device and/or a service on the basis of the access information associated with the identified communication device.

8. An apparatus, comprising:
means for determining a target direction on the basis of a user input;
means for identifying a communication device residing substantially at the target direction;
means for receiving, before or after the identification of the communication device, access information associated with the communication device without establishing a connection to the communication device and without any information of an earlier connection to the communication device; and
means for connecting the communication device and/or a service on the basis of the access information associated with the identified communication device.

9. The apparatus according to claim 7, wherein the apparatus is configured to estimate the target direction by estimating gaze direction by a gaze tracking module.

10. The apparatus according to claim 7, wherein the apparatus is configured to: receive a radio signal comprising at least one identifier of at least one locally available device,
estimate a direction of arrival of the received radio signal,
determine which identifiers are received substantially from the same direction as the target direction identified on the basis of the user input, and
select at least one identifier received substantially from the same direction as the direction identified on the basis of the user input.

11. The apparatus according to claim 7, wherein the apparatus is configured to capture an image on the basis of the user input; and
the apparatus is configured to perform or request an object identification procedure on the basis of the captured image resulting in an identifier or a shape, wherein the access information comprises an identifier or a shape substantially matching with the identifier or the shape obtained as the result of the object identification procedure.

12. The apparatus according to claim 7, wherein the access information comprises at least one of: one or more identifiers associated with the communication device, one or more access parameters associated with the communication device, and service information on services available via the communication device.

13. The apparatus according to claim 7, wherein the apparatus is configured to receive the access information together with further access information on other locally connectable devices automatically from a local access information server maintaining a dynamic database on locally connectable devices and associated access information.

14. A computer readable storage medium comprising one or more sequences of one or more instructions which, when executed by one or more processors of an apparatus, cause the apparatus to perform the steps in claim 1.
